(19) United States
(12) Patent Application Publication
(10) Pub. No.: US 2012/0272178 A1
(43) Pub. Date: Oct. 25, 2012

(54) METHOD AND DEVICE FOR PROVIDING EASY ACCESS IN A USER AGENT TO DATA RESOURCES RELATED TO CLIENT-SIDE WEB APPLICATIONS

(75) Inventors: Karl Anders Øygard, Oslo (NO); Arnstein Osnes Teigene, Oslo (NO); Marcos Caceres, Oslo (NO)

(73) Assignee: OPERA SOFTWARE ASA, Oslo (NO)

(21) Appl. No.: 13/091,926

(22) Filed: Apr. 21, 2011

(51) Int. Cl. G06F 3/048

(52) U.S. Cl. 715/781

(57) ABSTRACT

The present invention is directed toward a computer implemented method and device for providing a user with easy access to a plurality of frequently accessed data resources, including at least one web application. The invention provides a user agent (e.g., web browser) in which graphical representations, which are associated with the data resources, are displayed within particular locations of a window. A user invocable instruction (e.g., mouse click or a particular keystroke combination) may be associated with each of the graphical representations and their respective locations in the window. Accordingly, a user invocable instruction may be associated with the window location associated with a particular web application, thereby triggering an event in the application which in turn, e.g., can cause the user agent to retrieve a related data resource.

### CROSS-REFERENCES TO RELATED APPLICATIONS

The present application is related to co-pending U.S. application Ser. No. 11/976,086 filed Oct. 19, 2007 and the entire contents of which is hereby incorporated by reference.

### FIELD OF THE INVENTION

The invention relates generally to computer resource access, and more particularly to accessing content from client-side web applications via a user agent such as a web browser.

### BACKGROUND OF THE INVENTION

Computer users typically use user agent applications to access documents or data resources that are available over a computer network to which their computer is connected. Such resources are identified by a Uniform Resource Identifier (URI), usually a Uniform Resource Locator (URL), which identifies the resource uniquely and provides the information necessary for locating and accessing the resource. A web browser is a type of user agent commonly used to navigate the World Wide Web (i.e., the system of interlinked hypertext documents accessible on the Internet), in order to access a particular information resource (or “web page”) and present it to the user.

In addition to accessing documents or data resources, existing user agents such as web browsers are also capable of executing client-side applications which are designed to access information from various web services. Such applications may be installed on a client machine as a standalone application, or embedded in web pages that are downloaded from the Internet. An example of an application that a user agent might execute is a “widget,” a full-fledged client-side application that is authored using a web technology such as HyperText Markup Language (HTML), and packaged for distribution (e.g., according the Zip specification by PKWARE™). Such a widget may be programmed to receive updated information from a corresponding web service (e.g., by periodically polling the service for such information), and display it via a user interface element of the user agent. Accordingly, such applications may themselves be considered data resources.

It is contemplated that a user might desire to frequently view the content of certain web pages or applications via the user agent. As to web pages, existing web browsers are capable of maintaining a list of bookmarks or favorites in which users can save the URLs of web pages they want to revisit. Such browsers usually save the bookmarks in more or less a hierarchically structured manner, sorted by category. In addition, existing browsers allow users to select a home page (start page), which will be loaded when the browser starts. The home page can typically be a portal, a search engine, or a favorite site. As to applications, existing browsers allow for widgets and other types of web applications to be continually displayed in a window overlaying the currently active browser window, thus allowing the user to continue viewing the application's content even when the browser is being used to access other resources.

However, the above mechanisms are not very efficient. Since most users tend to visit only a few sites regularly, a hierarchical system for bookmarking a large number of web pages is inefficient for day to day browsing. Also, a single start page may bring a user to one favorite site, but if the user wants to visit a handful of sites in addition to the selected home page, he or she will have to resort to either navigating through the bookmark list or entering the URL (or at least the beginning of the URL) in the browser's address field. Furthermore, overlaying an application window on top of a browser interface can make it difficult for the user to view the resource that is displayed in the main browser window.

### SUMMARY OF THE INVENTION

The present invention is directed toward a computer implemented method and a device for providing a user of a user agent with easy access to applications and related data resources. The invention provides the user with a user interface where certain data resources, including one or more applications, are associated with graphical representations in predefined locations a browser window. Furthermore, a user can retrieve web pages or other type of resources associated with these applications through user-invocable commands (e.g., mouse clicks or keystroke combinations) associated with the predefined locations, respectively.

### BRIEF DESCRIPTION OF THE DRAWINGS

FIG. 1 is a computing device that can be used to implement an exemplary embodiment of the present invention;

FIG. 2 is a user agent for accessing data resources in accordance with an exemplary embodiment of the present invention;

FIG. 3 is a user interface in accordance with an exemplary embodiment of the present invention; and

FIG. 4 is a flow chart illustrating how an application can be associated with a display location in accordance with an exemplary embodiment of the present invention.

FIG. 5 is a flow chart illustrating how a determination is made with regard to granting or denying an application's request to be associated with a display location in accordance with an exemplary embodiment of the present invention.

### DETAILED DESCRIPTION

The present invention is directed toward a computer implemented method and a device for providing a user with easy access to frequently used applications, as well as other types of frequently accessed data resources such as web pages. The method may typically be implemented as part of a user agent, e.g., a web browser, for providing the user with graphical representations of a limited number of preferred resources (applications, web pages, and the like). Each graphical representation may be associated with an application and/or the URL of a web page such that, when the user performs an action signifying a selection of the graphical representation (e.g. clicks on it with a mouse), the user agent is instructed to trigger an operation of the associated application and/or retrieve and display the web page located at the associated URL. Further, these graphical representations may be associated with predefined locations of a particular window, e.g., a browser window, which is displayed at startup of a web browser or displayed in response to a user command. When this particular window is displayed by the user agent, the graphical representations are displayed in their respective predefined locations.

For instance, a web application or widget may be executed by a user agent as a result of having been embedded in a retrieved web page, downloaded as a standalone application or an update to the user agent, or directly installed into the client machine as a standalone or update. Any such application may include code that, upon execution by the user agent, is interpreted as a request to be associated with one of the predefined locations. In response, the user agent may determine whether such request should be granted (e.g., by asking the user) and, if granted, display a corresponding graphical representation of the application in one of the predefined locations.

Furthermore, as part of its request, the application may further specify what type of graphical representation will be displayed in the predefined location. For instance, by declaring a particular attribute (e.g., a particular type of view mode) in its request, the application may notify the user agent that the graphical representation should display dynamic content (e.g., a background process) of the application. Alternatively, or in addition to such dynamic graphical representation, the applicant may explicitly associate itself with an icon to be displayed. However, if neither a dynamic graphical representation nor a specific icon is indicated as part of the application's request, the user agent may display a placeholder icon in the predefined location associated with the application.

Moreover, the user agent may include an application program interface (API) which allows for an application, whose request has been granted, to change or update the graphical representation that is displayed. For instance, this API may be exposed to the application only after the user agent has granted the application's request to be associated with one of the predefined locations.

As described above, a web application may include a coded request which, when executed by the user agent, causes the application to be associated with one of a plurality of predefined locations in a displayed window. However, for other data resources (documents and the like), user interaction may be required to associate such resource with another one of the other predefined locations in the window. In such cases, the corresponding graphical representation may be generated, e.g., as a thumbnail image of the data resource.

For purpose of this specification and accompanying claims, the following definitions will be used. An “application” is defined as computer software designed to perform a singular or multiple related specific tasks for a user or other application programs. Further, a “web application” is defined as an application coded according to a web standard, and reliant on a user agent (e.g., browser) to be rendered executable. A web application is typically written in a browser-supported language, e.g., a markup language, e.g., HTML, possibly combined with a scripting language, e.g., JavaScript. Furthermore, a “widget” is defined as a particular type of web application that is packaged for distribution, and may be downloaded to the client as a standalone application or embedded in a web page. A further description of widgets can be found in “Widget Packaging and Configuration” (Working Draft), edited by Marcos Cáceres, published by World Wide Web Consortium (W3C), Mar. 22, 2011 (hereafter referred to as “W3C-Widgets”), the entire contents of which are hereby incorporated by reference.

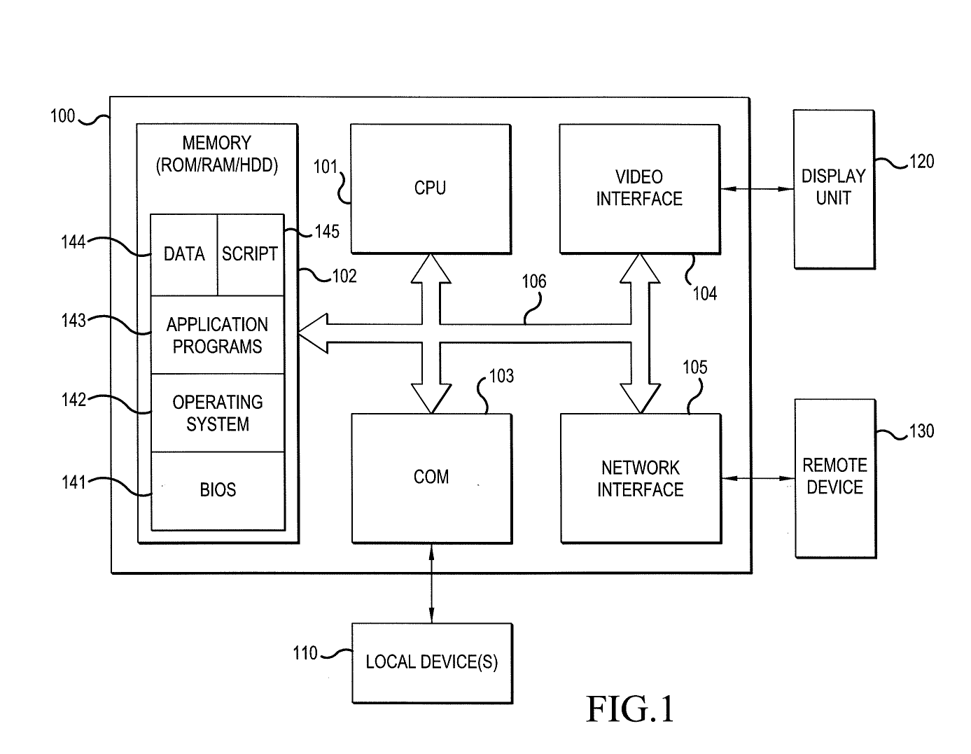

FIG. 1 illustrates a generalized computing device 100 that can be used as an environment for implementing various aspects of the present invention. In FIG. 1, a device 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memory, stores the various software components of the system. The software components in the memory 102 may include a basic input/output system (BIOS) 141, an operating system 142, various computer programs 143 including applications and device drivers, various types of data 144, and other executable files or instructions such as macros and scripts 145. For instance, the computer programs 143 stored within the memory 102 may include any number of applications, including web applications and widgets, designed to be executed in a user agent environment in accordance with principles of the present invention.

In FIG. 1, the communication ports 103 may be connected to one or more local devices 110 such as user input devices, a printer, a media player, external memory devices, and special purpose devices such as e.g. a global positioning system receiver (GPS). Communication ports 103, which may also be referred to as input/output ports (I/O), may be any combination of such ports as USB, PS/2, RS-232, infra red (IR), Bluetooth, printer ports, or any other standardized or dedicated communication interface for local devices 110.

The video interface device 104 is connected to a display unit 120 which may be an external monitor or an integrated display such as an LCD display. The display unit 120 may have a touch sensitive screen and in that case the display unit 120 doubles as a user input device. The user input device aspects of the display unit 120 may be considered as one of the local devices 110 communicating over a communication port 103.

The network interface device 105 provides the device 100 with the ability to connect to a network in order to communicate with a remote device 130. The communication network, which in FIG. 1 is only illustrated as the line connecting the network interface 105 with the remote device 130, may be, e.g., a local area network or the Internet. The remote device 130 may in principle be any computing device with similar communications capabilities as the device 100, but may typically be a server or some other unit providing a networked service.

It will be understood that the device 100 illustrated in FIG. 1 is not limited to any particular configuration or embodiment regarding its size, resources, or physical implementation of components. For example, more than one of the functional components illustrated in FIG. 1 may be combined into a single integrated unit of the device 100. Also, a single functional component of FIG. 1 may be distributed over several physical units. Other units or capabilities may of course also be present. Furthermore, the device 100 may, e.g., be a general purpose computer such as a PC, or a personal digital assistant (PDA), or even a cellphone or a smartphone.

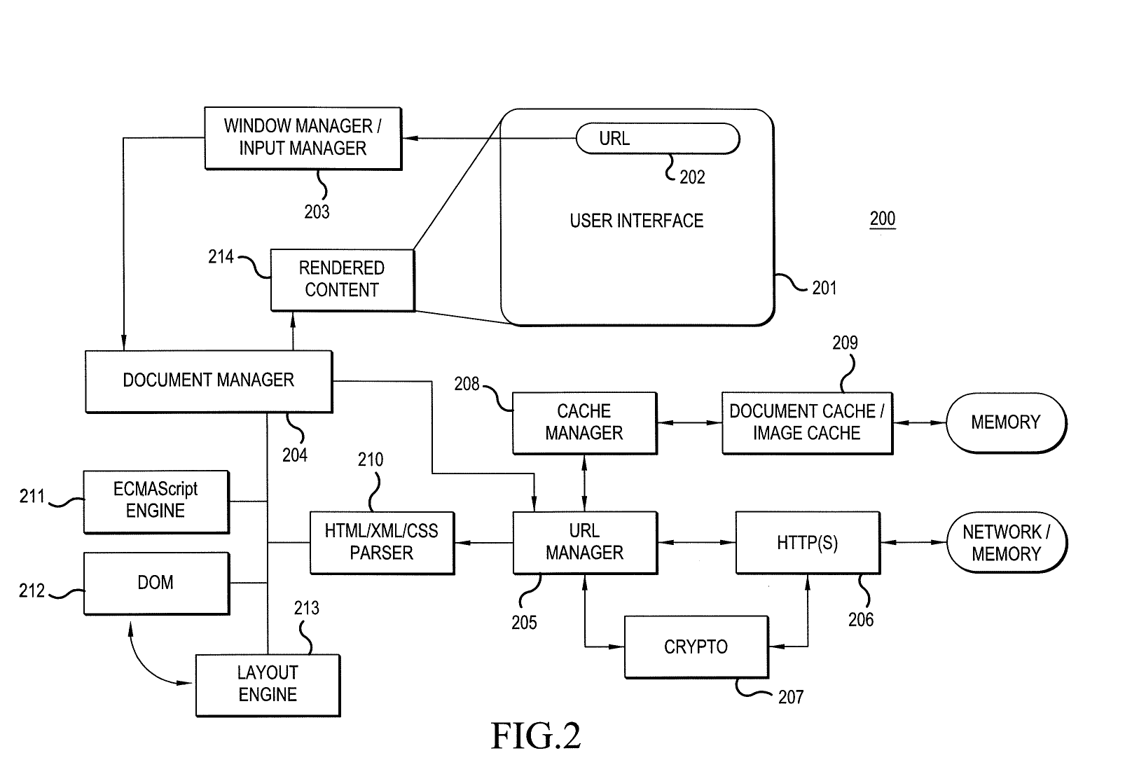

In an exemplary embodiment, various aspects of the present invention may be incorporated into, or used in connection with, the components and/or functionality making up a user agent or browser installed as an application on a device 100. FIG. 2 shows an example of a number of modules that may be present in such a user agent or browser. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The user agent or browser 200 presents the user with a user interface 201 that may be displayed on the display unit 120 shown in FIG. 1. The user interface 201 may include an address field 202 where the user may input or select the URL of a document or a service he or she wants the user agent 200 to retrieve. For example, the user may use an input device (e.g., keyboard) to type in the URL in the address field 202. The address field 202 may also be a link that is displayed and may be activated by the user using a pointing device such as a mouse. Alternatively the URL may be specified in the code of a document or script already loaded by the user agent 200.

In any case, the URL may be received by a window and input manager 203 that represents the input part of the user interface 201 associated with, or part of, the user agent 200. The URL may then be forwarded to a document manager 204, which manages the data received as part of the document identified by the URL.

The document manager 204 forwards the URL to a URL manager 205, which instructs a communication module 206 to request access to the identified resource. The communication module 206 may be capable of accessing and retrieving data from a remote device 130 such as a server over a network using the hypertext transfer protocol (HTTP), or some other protocol such as HTTPS or FTP. The communication module 206 may also be capable of accessing data that is stored in local memory 102.

If communication outside the device 100 is required to be encrypted, e.g. as specified by the protocol used to access the URL, encryption/decryption module 207 handles communication between the URL manager 205 and the communication module 206.

The data received by the communication unit 206 in response to a request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL manager 205 forwards the data received from the communication port 206 or cache 209 to a parser 210 capable of parsing content such as HTML, XML and CSS. The parsed content may then, depending on the type and nature of the content, be processed further by an ECMAScript engine 211, a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

When the data representing the content of the specified document has been processed it is forwarded from the document manager 204 in order to be rendered by a rendering engine 214 and displayed on the user interface 201.

The various modules thus described are executed by the CPU 101 of device 100 as the CPU 101 receives instructions and data over the system bus(es) 106. The communications module 206 communicates with the remote device 130 using the network interface 105. The functionality of various modules in FIG. 2 may of course be integrated into fewer larger modules. Also, the functionality of a single module in FIG. 2 may be distributed or replicated over several modules.

It will further be understood that, while the user agent 200 described above may be implemented as an application program 143, some of the user agent's 200 functionality may also be implemented as part of the operating system 142 or even the BIOS 141 of the device 100. The content received in response to a URL request may be data 144, script 145, or a combination thereof as further described below.

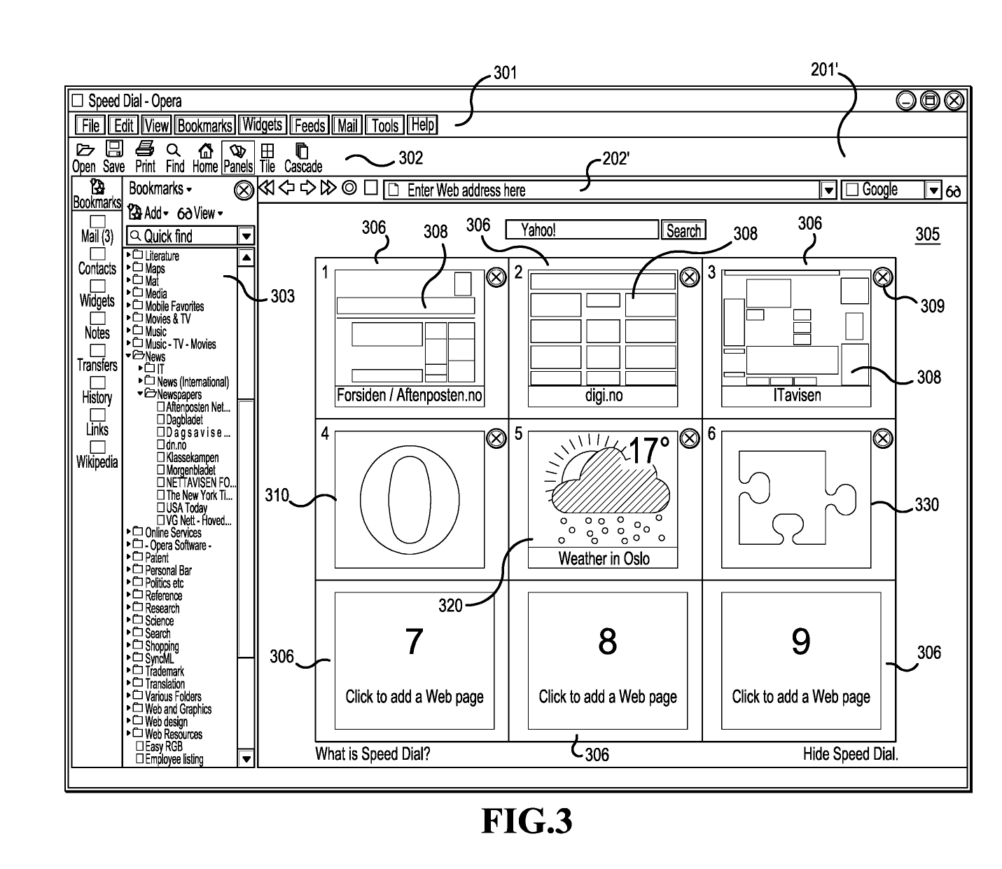

Reference is now made to FIG. 3, which shows a view of a particular example of a user interface 201′ of a web browser 200′. The user interface 201′ according to this particular example includes a toolbar 301 including a number of drop-down menus, another toolbar 302 including a number of buttons that provide quick access to certain functions, a sidebar window 303 showing a bookmark list, an address field 202′, and a main window 305.

Principles of the present invention will be described below in connection with the particular example of a web browser 200′ as illustrated in FIG. 3. However, such description is not intended to limit the invention to such a web browser 200′, and the principles described hereinbelow will equally apply to other types of user agents 200 as will be contemplated by persons of ordinary skill in the art.

Referring to FIG. 3, either of the two toolbars 301 and 302 may be configured to provide access to an application (e.g., widget) that has been installed within the web browser 200′. Consider, for example, where an installed widget conforms to the specifications set forth in W3C-Widgets. Such widget may include several files packaged together, including a start file that defines various user interface elements in the browser 200′ for the widget. For instance, the start file may insert an item in one of the drop-down menus in toolbar 301, and/or create a button in toolbar 302, which are used to activate the widget to perform some functionality like generating a popup window to display some content. However, it may be cumbersome for the user to search for the corresponding item or button in these toolbars, and also the popup window can be hidden behind the browser window.

Furthermore, as shown in FIG. 3, the bookmark list in the sidebar window 303 is a list of web resources organized hierarchically according to categories. A user may access a particular web resource, e.g., the web page of a newspaper, by first clicking on the folder marked “News,” then on the folder marked “Newspapers,” and finally on the bookmark representing the particular newspaper he or she wants to access. The browser 200′ will then access the web site, retrieve the information associated with it and display a rendered version of the newspaper web site, as described above with respect to FIG. 2. However, certain web sites may be accessed particularly often, and it is inefficient for the user to have to navigate through a hierarchically organized list every time such a site is desired.

According to an exemplary embodiment of the present invention, when an empty browser window is opened, graphical representations of applications and favorite web pages may be displayed in a plurality of predefined locations, respectively. This is illustrated by way of an example in FIG. 3, where the main window 305 contains nine predefined locations 306 reserved for such graphical representations. In this particular example, the first three locations 306 are occupied by graphical representations of three different web pages, the fourth through sixth locations 306 are occupied by graphical representations associated with three different web applications, and the seventh through ninth locations are still empty. As shown in the example of FIG. 3, the graphical representations are generated to be roughly the same shape and size, but this need not always be the case. It is contemplated that there may be variations in the size and shape of the graphical representations, e.g., larger graphical representations may be displayed for resources likely to be accessed more frequently, or otherwise deemed more important, by the user.

Each of the predefined locations 306 may correspond to positions within the main window 305 as defined by an algorithm within the web browser 200′. According to an exemplary embodiment, such algorithm may be designed to recalculate these positions each time the main window 305 is resized, e.g., to provide for optimal viewing of the graphical representations. Alternatively, such algorithm may be designed maintain the same positions for the predefined locations 306 when the window 305 is resized.

As illustrated in FIG. 3, the graphical representation of each web page may be generated as thumbnails 308 (i.e., small images that represent a scaled down version of the actual web page) and associated with one of the predefined locations 306 in accordance with principles set forth e.g., in the co-pending U.S. patent application Ser. No. 11/976,086 filed Oct. 19, 2007, the entire contents of which is hereby incorporated by reference. Furthermore, for each web page, a user-invocable command may also be associated with the location 306 (e.g., clicking on the location 306, pressing a unique keystroke combination, etc.) in accordance with principles set forth in the aforementioned patent application, so that the browser 200′ retrieves and renders the associated web page when the user-invocable command is performed.

As to applications, FIG. 3 illustrates by way of example that three different types of graphical representations may be used. For instance, in this particular example, a custom icon 310 is used to represent the application associated with the fourth location 306. The application itself may provide (or at least identify) the custom icon to the browser 200′. The custom icon may depict, e.g., a functionality or characteristic of the application, or even a web site that is somehow related to the application.

Referring again to FIG. 3, a graphical representation for an application is illustrated in the fifth location 306, i.e., a dynamic graphical representation of content 320 that is updatable by the application. FIG. 3 shows a particular example where the fifth location 306 is associated with a web application (e.g., widget) for providing updated weather information for a particular location (Oslo, Norway). Thus, the corresponding dynamic graphical representation 320 is capable of displaying content that can be updated by the application, such as a general pictorial representation of weather conditions, and textual information indicating temperature. According to an exemplary embodiment, this dynamic graphical representation 320 may display the results of a background process of the application that is continually running (as will be described in more detail below).

Also, the dynamic graphical representation of content 320 may include a title (e.g., “Weather in Oslo”) to further describe the content. However, the use of titles is not limited to dynamic graphical representations 320, and may also be displayed in connection with other types of graphical representations (e.g., custom icon 310).

FIG. 3 also illustrates a third type of graphical representation, in the sixth location 306, which may correspond to an application. Particularly, a default placeholder icon 330 may be provided by the user agent 200 for situations where the application does not support another type of graphical representation. As shown in FIG. 3, such placeholder icon 330 performs the function of indicating that corresponding location 306 is associated with an application, and thus distinguish it from the empty locations 306 which are still available (examples of which are the sixth through ninth locations 306 in FIG. 3).

According to an exemplary embodiment, the browser 200′ maintains a list of applications and web pages which are associated with predefined locations 306. Such list may be stored, for example, in a configuration file or a similar location. Each entry of this list may be linked to a particular one of the predefined locations 306 in the main window 305, and may include a unique identifier of the application, or a URI of the web page, which is associated with that location 306.

According to an exemplary embodiment, even if a particular location 306 is associated with an application, the list may also store a URI (e.g., URL) in association with such location 306. For example, the list may associate the location 306 with the URI of a data resource (e.g., web page) that is of particular relevance to the associated application. Furthermore, the web browser 200′ may be configured to load and display the relevant data resource when the user performs a user-invocable command corresponding to the location 306 that is associated with the application. Such user-invocable commands may comprise the clicking of a mouse at the corresponding location 306 of the main window 305. However, other types of user-invocable commands, e.g., keystroke combinations, may also be associated with the respective locations 306 for applications (as well as web pages), as will be described in more detail below.

When each application is associated with one of the predefined locations 306, a corresponding graphical representation 308 may be created and stored as an image file, e.g., in a cache memory maintained by the browser 200′. In accordance with an embodiment consistent with the principles of the invention, the image files may be stored in a document and image cache 209 in local memory 102 as already described. Alternatively, the image files may be stored and administered separately from other cached elements.

In the case where the graphical representation of an application is a custom icon 310 or placeholder icon 330, the graphical representation may already be provided, either by the application or the web browser 200′, in an image file format (e.g., JPG or PNG). On the other hand, if the graphical representation is a dynamic graphical representation of content 320, the rendering and creation of the corresponding image file may be first performed at the time the application is associated with a predefined location 306, and then repeated whenever the graphical representation is to be updated or changed. For instance, when a dynamic graphical representation 320 corresponding to a widget is associated with one of the predefined locations 306, the web browser 200′ may continually monitor “events” issued by a background process of the widget regarding updates or changes to the graphical representation. In response to any such events, the browser 200′ may then re-create the image file to implement such updates or changes. Further details regarding this aspect of the invention will be described below.

However, it is not always necessary to create an image file as the graphical representation of an application. As an alternative, for example, in the case where a dynamic graphical representation of content 320 is to be displayed, a background process (e.g., of a widget) may be rendered directly to the screen at the corresponding location 306 in the main window 305. Such direct rendering could be advantageous from a performance perspective.

In cases where a graphical representation (e.g., image file) is created and stored for an application, such stored graphical representation must be associated with the proper location 306 in the main browser window 305. Several alternatives are within the scope of the invention. By way of example, an identification of the image file may be entered in the list that links the identifier of the application with its associated location 306 (and the related URI or URL, if provided). Alternatively, there may be a direct association between each location 306 and a particular image file, e.g., to facilitate potentially frequent updates of a dynamic graphical representation of content 320.

Referring again to FIG. 3, in addition to the graphical representations, the predefined locations 306 may include additional user interface (UI) elements 309. These elements 309 may represent additional user-invocable functions such as “reload,” “clear,” etc. (for example, FIG. 3 illustrates an element 309 representing a “clear” function).

According to an embodiment consistent with principles of the present invention, the main window 305, the various locations 306, and the elements displayed thereon (including graphical representations 308, 310, 320, and 330, and UI elements 309) may be hierarchical user interface elements. The main window 305 (or the user interface element displayed in the main window 305 when the invented method is invoked) is a user interface element at a first level. The various locations 306 may be user interface elements subordinate to the main window element 305, and the various parts of the locations 306 (such as graphical representations and UI elements 309) may again be subordinate to the locations 306.

It will be realized by those of ordinary skill in the art that this organization of user interface elements is similar to that which is common in the “chrome” (i.e., the borders and controls that frame the content part of a “window”) of a user interface. As an example, in FIG. 3, the buttons 302 may be subordinate to a “main bar” user interface element which, if hidden, results in the hiding of all the buttons 302.

According to one embodiment consistent with the principles of the invention, the locations 306 themselves may comprise thumbnail applets. Generally speaking, an applet is an interface element that a computer user interacts with. Applets may sometimes be thought of as small, dependent computer programs that are displayed by a host software system, which may be part of a window manager system or a web browser. According to the present invention, the functionality of the web browser 200′ may be used to display the thumbnail applets.

Referring again to FIG. 3, the web browser 200′ will need to generate the actual page that displays the graphical representations at the respective predefined locations 306 in the window 305. According to one embodiment, this page is an HTML document that is loaded automatically as a default page when the user instructs the browser 200′ to open a new empty browser window 305. Alternatively, this page may be an HTML document that is automatically loaded into a current window 305 in response to a user input, e.g., clicking a link or button in the current window 305. Such a document may contain references to the various elements on the page, including the thumbnails 308 and any files containing URIs.

According to an alternative embodiment, the page is generated natively in the code of the browser 200′. For instance, the browser 200′ may be designed to generate this page automatically when a new empty browser window 305 is opened, or when a particular input is received from the user.

Further, exemplary embodiments of the invention may be implemented to replicate a “speed dialing” function in the web browser 200′. For example, in one such embodiment, the graphical locations which are displayed at the locations 306 may be associated with different numbers. Accordingly, the user may be able to provide a number-based input as a user-invocable command associated with each web page or application. For instance, if the user enters a number in the browser's address field 304, the browser 200′ may be configured to load and display the web page whose URI is associated with the corresponding location 306. The number may also be part of a particular keystroke or keystroke combination. As an example, the browser 200′ may be configured to load the web page which is associated with the location 306 designated as “1” in response to the user pressing the key combination CTRL+1.

In another embodiment of the invention regarding the “speed dialing” feature, each location 306 may be associated with a number regardless of whether a graphical representation of a web page or application is displayed at that location 306. This is consistent with the example shown in FIG. 3, where the various locations 306 are associated with the numbers 1-9 (i.e., a graphical representation of a web page or application is displayed in each of the locations 306 respectively associated with digits 1-6, while no graphical representations are yet displayed at the locations 306 respectively associated with digits 7-9). For example, if the user were to type the key combination CTRL+3, the resource whose URI is associated with the location 306 associated with “3” is retrieved. However, in this example, if the user were to type CTRL+7, the user may simply be given the option of inputting the URI of a resource to be displayed, since the location 306 associated with “7” is not yet associated with any URI.

Regardless of whether numbers are associated with the graphical representations or locations 306, this “speed dialing” feature of a browser 200′ offers the user functionality similar to the speed dialing function of a telephone. Whereas the phone speed dialing function allows the user to make a call using a simple one- or two-digit number rather than dialing the entire phone number, the above-described “speed dialing” embodiments may allow a user to use a simple number to retrieve a data resource (e.g., web page) rather than typing in the corresponding URI.

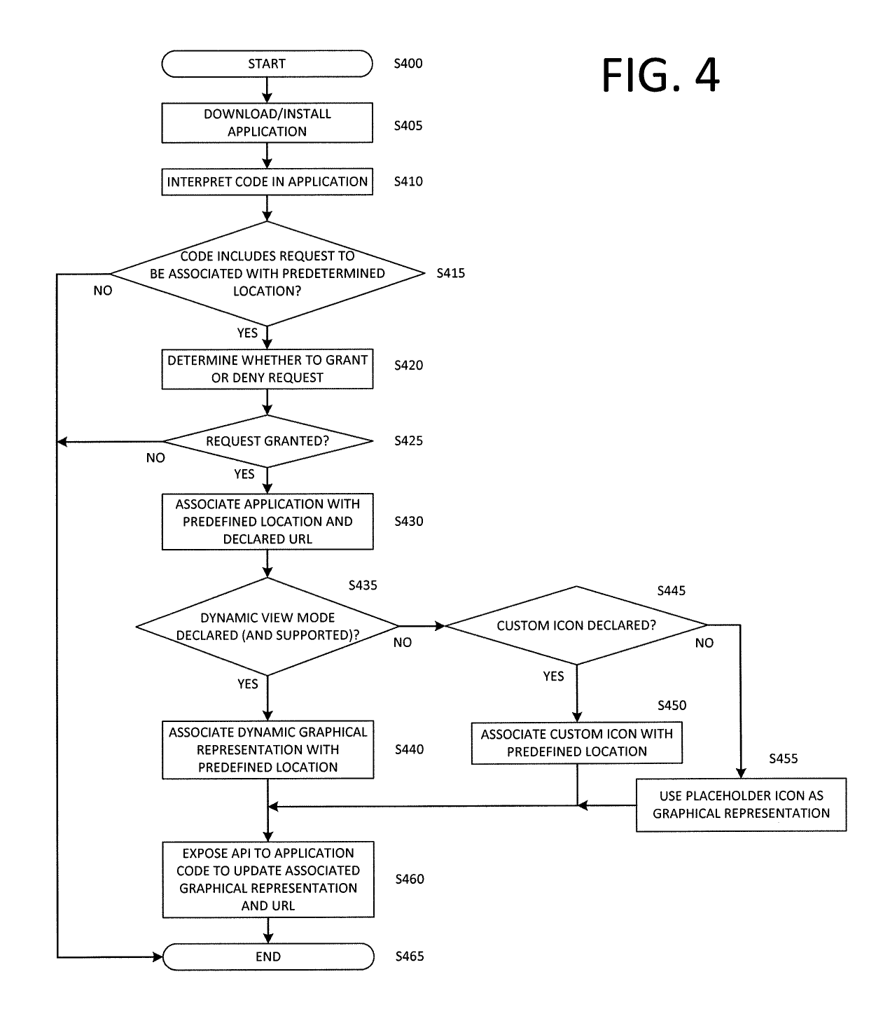

Reference is now made to FIG. 4, which is a flowchart illustration of how, according to one embodiment of the invention, the process by which the feature of associating an application with a predefined location 306, along with the corresponding graphical representation and URI, can be implemented within a web browser 200′. For the sake of brevity, such feature will be referred to hereinbelow as “the Speed Dialing feature” of a browser 200′ (however the use of such term in the following description is not intended to impose any requirement as to the numerical assignment of locations 306, or the use of user-invocable commands that are based on numbers).

The process starts according to step S400. In step S405, an application is downloaded or installed in the computer device 100. If the application is a web application or widget, it may be downloaded by the web browser 200′ over the Internet or an intranet from a particular URI is accessed. The application may be downloaded by itself, be downloaded in combination with other files (e.g., as part of a browser update), or embedded in a web document that is retrieved by the browser 200′.

In step S410 of FIG. 4, the web browser 200′ interprets the code within the application. This may be performed when the browser 200′, e.g., instantiates a downloaded widget. For example, if the web browser 200′ obtains a widget conforming to the specifications of W3C-Widgets, such widget may contain a start file that is loaded and interpreted by the browser 200′ upon instantiation. While interpreting the code, the web browser 200′ tries to detect whether the application includes a coded “request” to associate the application with one of the predefined locations 306, according to principles of the present invention, as shown in step S415. According to an exemplary embodiment, the web browser 200′ may be programmed to search for such request in a particular partition of code, e.g., a configuration file or the like.

Specific examples will now be presented as to how an application may request itself to be associated with one of the predefined locations 306 of a main window 305 (i.e., request availability of the Speed Dialing feature). For these examples, it is assumed that the application is a widget in conformance with W3C-Widgets. Such a widget contains, in addition to the aforementioned start file, a configuration document which is written in eXtensible Markup Language (XML) document. (Generally, such widget will also contain various other files packaged together with the start file and configuration document, but these additional files need not be described for purposes of this description.) In the configuration document, the developer can provide metadata regarding the widget (name of widget, description of widget, author name, etc.).

However, the widget developer may also insert a “feature” element in the configuration document to request the availability of a feature of the web browser 200′, such as the Speed Dialing feature. Furthermore, in addition to requesting availability of the Speed Dialing feature, the widget's configuration document can also be used to declare what content should be displayed in the corresponding graphical representation.

According to a further exemplary embodiment, the Speed Dialing feature may be implemented in the web browser 200′ as a runtime component within the browser 200′, which may include an Application Programming Interface (API). If and when the browser 200′ grants the feature request to the widget, the browser 200′ may then expose the API to the widget's code (e.g., scripts) so that the widget can use the API to modify or update the corresponding graphical representation and URI (as will be described in more detail below).

An example of a configuration document, which includes a feature element for requesting the availability of the Speed Dialing feature, is provided in Table 1 below:

TABLE 1

1 <widget
2 xmlns = “http://www.w3.org/ns/widgets”
3 viewmodes=“minimized”>
4 <content src=“weather.html”/>
5 <name short=“Weather”>
6 The Weather in Oslo
7 </name>
8 <feature name=“opera:speeddial”
9 required=“false”>
10 <param name=“url”
11 value=“http://weather.com”/>
12 </feature>
13 </widget>

In this example, the Speed Dialing feature of the browser 200′ has the feature name “opera:speeddial.” Accordingly, the configuration document includes a feature element (lines 8-12) whose name attribute is “opera:speeddial” (line 8). Accordingly, this feature element is interpreted by the browser 200′ as requesting availability of the Speed Dialing feature.

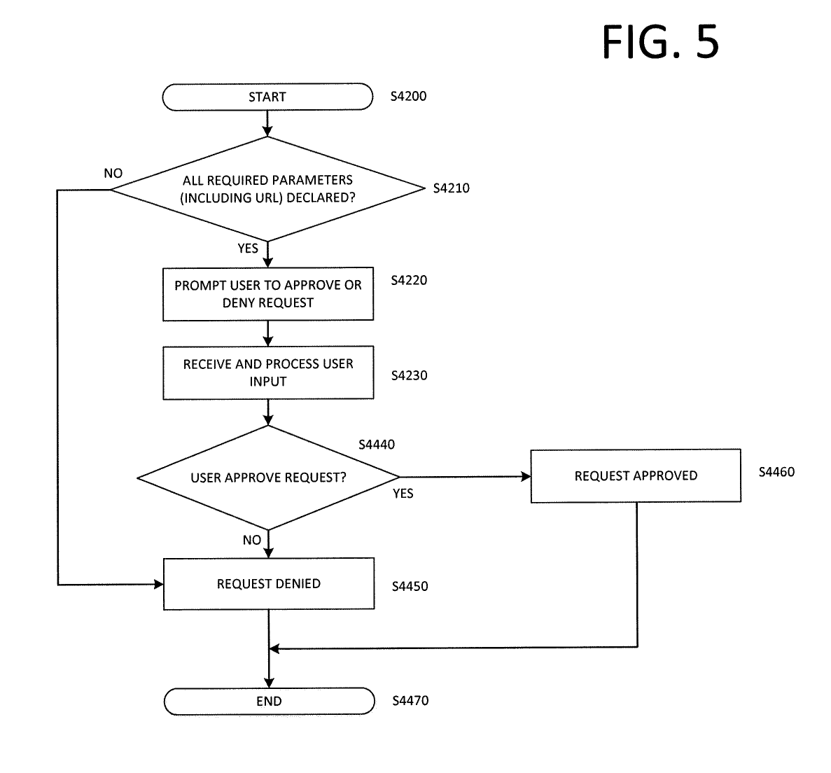

Referring again to FIG. 4, in step S420, a determination is made by the browser 200′ as to whether the application's request for the Speed Dialing feature should be granted or denied. FIG. 5 illustrates an example of a process for making this determination.

In FIG. 5, the process beings at step S4200. In step S4210, a determination is made as to whether the request for the Speed Dialing feature includes all the required parameters, or otherwise meets all requirements. If not, the request is denied in step S4450. For instance, in one exemplary embodiment of the invention, the browser 200′ can require the request to include a URI which represents the location of a data resource which should be retrieved in response to the user performing the associated user-invocable command. As such, if no URI is provided in connection with the request, the browser 200′ may automatically deny the request. A specific example of this is shown in the configuration document of Table 1 above, in which the feature request includes a “param” element for declaring the URL parameter of the Speed Dialing feature in lines 10-11.

Referring again to FIG. 5, if the request meets all of the requirements, the process proceeds to step S4220 in which the browser 200′ requests the user's express authorization to grant the request to the particular application. For instance, the browser 200′ may display a popup window identifying the requesting application, and asking the user for input approving or denying the application access to the Speed Dialing feature. In response, according to step S4230, the user inputs his or her response, and the input is processed accordingly by the browser 200′. Then, according to step S4440, the request is either denied (step S4450) or approved (step S4460) based on the user input. This concludes the process as shown by step S4470.

It should be noted that FIG. 5 is provided for purpose of example, and not intended to be limiting on the present invention. Further, the present invention encompasses any obvious modifications of the process of FIG. 5 as would be contemplated by persons of ordinary skill in the art. This could include any obvious reordering of the steps illustrated in FIG. 5, or providing any additional obvious steps to the process. An example might be to add a step for determining whether all of the predefined locations 306 are already occupied by other data resources, and if this is the case, automatically denying the application's request (or otherwise asking the user whether the current application should replace any of the other resources utilizing the Speed Dialing feature).

Another obvious modification of the process of FIG. 5 would be to omit step S4440, i.e., the step of requesting the user's express authorization to grant the application's request, at least in certain circumstances. For instance, it may be possible to configure the browser 200′ to allow the user to specifically assign an application to the Speed Dialing feature before the application code (and the request) is even analyzed. In such a case, the user's authorization would be implied, and it would not be necessary to request his/her express authorization at step S4440.

Returning to FIG. 4, if the browser 200′ denies the application's request for the Speed Dialing feature (e.g., according to the process of FIG. 5), there is no need to associate the application with any of the predefined locations 306, and processing concludes at step S465. Conversely, if the application's request is granted, the browser 200′ selects a location 306 to be associated with the application and the corresponding URI in step S430. For instance, the browser 200′ may choose the next unoccupied location 306 in the sequence of numbers assigned to the respective locations 306 (in case such numbers are assigned). Alternatively, the browser 200′ may be configured to provide drag-and-drop functionality, whereby a user can use a pointing device (e.g., mouse) to drag a graphical representation of the application to a particular one of the locations 306 and drop it there, thus causing the application to become associated with the particular location 306. In this case, if a data resource is already associated with the particular location 306, the old resource may be replaced by the application, possibly after the user is asked to confirm. However, various other methods may be utilized to select an appropriate location 306 for the application as would be readily contemplated by persons of ordinary skill in the art.

It is noted that FIG. 4 illustrates step S430 as being performed prior to the steps which determine the actual type of graphical representation that will correspond to the application. However, as suggested in the above discussion regarding the potential drag-and-drop functionality, the process of FIG. 4 could be modified to perform step S430 after the graphical representation has already been created, e.g., so that the user can drag and drop such graphical representation at a desired one of the locations 306 for association therewith.

Referring again to FIG. 4, steps S435-S455 illustrate a particular exemplary embodiment in which a browser 200′ can determine what type of graphical representation should be generated for the application, on the basis of particularities of the application's request. According to these steps, the browser 200′ interprets the presence or absence of certain information, within the partition of code (e.g., configuration file) containing the request, as determinative of the type of graphical representation of the application to be used.

According to an exemplary embodiment of the invention, the application code could request a dynamic graphical representation of content 320 by indicating to the browser 200′ that a background process of the application should be displayed. For instance, the application code could declare a particular type of view mode (hereafter referred to as a “dynamic view mode”) which is interpreted by the browser 200′ to mean that the application's background process should be displayed as the corresponding graphical representation. Thus, as shown in step S435, the browser 200′ may check whether the application code has declared that a dynamic view mode of the application is to be used in connection with the Speed Dialing feature. If so, this could indicate to the browser 200′ that the application is requesting that a dynamic graphical representation of the application's content 320 be displayed in connection with the Speed Dialing feature. To illustrate this, reference will again be made to the specific example of a widget conforming to the W3C-Widgets standards whose configuration file is illustrated in Table 1. As shown in this example, a configuration file which requests the Speed Dialing feature (lines 8-12) also requests that the background process of the widget be displayed by declaring a dynamic view mode (which, in this particular example is the “viewmodes=‘minimized’” attribute in line 3). This dynamic view mode is interpreted by the browser 200′ as a request for a dynamic graphical representation of content 320 and, more specifically, as a request to display the background process of the widget.

However, it is possible for a web browser 200′ to incorporate the Speed Dialing feature according to principles of the invention without supporting the functionality of providing a dynamic graphical representation of content 320 in the associated location 306. For instance, this may be the case where the programming of the web browser 200′ simply does not include such functionality, or where the browser 200′ is operating according to a particular user setting. Thus, as indicated in steps S435 and S440 of FIG. 4, a dynamic graphical representation of content 320 is associated with the application only when it is appropriately requested by the application and it is supported by the browser 200′.

In cases where the dynamic graphical representation of content 320 is requested by the application and also supported by the browser 200′, the browser 200′ will associate such representation with the corresponding location 306 as shown in step S440 of FIG. 4. Thereafter, the browser 200′ may expose an API to the application in step S460, thus allowing the application to update the content of the dynamic graphical representation 320, as well as control certain other aspects of the Speed Dialing feature (e.g., change the associated URI, add/change a title).

As mentioned earlier, according to an exemplary embodiment, such dynamic graphical representation of content 320 may start displaying a background process of the application, i.e., a process that is constantly running in the background for the lifetime of the application. Such background process may be used to regularly poll a web service and update the application's dynamic graphical representation 320 with information. For instance, in the particular example shown in FIG. 3, the widget associated with the fifth location 306 can regularly poll a web service providing current weather information in order to update the displayed temperature, as well as change the pictorial representation when necessary. Another example would be a background process that regularly polls a mail service, and updates the corresponding graphical representation to display the unread mail count. The browser 200′ may be configured to continually monitor notifications or “events” that are issued by the application to implement such updates.

If the application is a widget in conformance with W3C-Widgets, a start file may serve as the background process for the widget. This start file may be a custom start file, which is specifically identified within the “content” element of the configuration file. A specific example of this is provided in Table 1 above, in which configuration document identifies the file “weather.html” as the custom start file (see line 4) which will serve as the background process. If the configuration document does not identify a start file in its content element, the default start file may then serve as the background process. Furthermore, the start file may contain scripts (e.g., written in JavaScript language), or refer to external scripts in the widget package, for controlling and updating the content of the dynamic graphical representation 320 (and possibly poll web services for information, etc.)

Referring again to FIG. 4, if step S435 determines that the corresponding graphical representation will not be a dynamic graphical representation of content 320, the browser 200′ may check whether the application code has declared a custom icon 310 to be used as the graphical representation. A particular example of this is described below in connection with Table 2, which illustrates another configuration document for a widget conforming to the W3C-Widgets standards:

TABLE 2

1 <widget
2 xmlns = “http://www.w3.org/ns/widgets”>
3
4 <icon src=“opera.png”/>
5
6 <feature name=“opera:speeddial”
7 required=“false”>
8
9 <param name=“url”
10 value=“http://opera.com”/>
11 </feature>
12 </widget>

This may result in a graphical representation being displayed as shown in the fourth location 306 of the main window 305 illustrated in FIG. 3.

In the particular example of Table 2, the configuration document does not declare a dynamic view mode (since the “viewmodes=‘minimized’” attribute of Table 1 is omitted), and thus according to an exemplary embodiment is not interpreted by the browser 200′ as requesting a dynamical graphical representation of content 320. However, the configuration document does include an icon element (line 4) which declares the file “opera.png,” which may be provided as a separate file in the widget package, as the custom icon. In an exemplary embodiment, the browser 200′ will interpret the inclusion of such icon element in the configuration document as a request by the widget that the custom icon “opera.png” be used for the corresponding graphical represent to be displayed in the associated location 306 of the main window 305.

It should be noted that an application developer might declare a custom icon 310, even if he or she has also requested a dynamic graphical representation 320, e.g., by declaring a dynamic view mode. This might occur, e.g., if the developer wants to display a dynamic graphical representation of content 320 (e.g., the application's background process) at the associated location 306, but is willing to fall back to displaying the custom icon if the browser 200′ does not support such dynamic graphical representations 320. A specific example of this is shown in Table 3 below, with regard to a configuration document in conformance with W3C-Widgets:

TABLE 3

1 <widget
2 xmlns = “http://www.w3.org/ns/widgets”>
3 viewmodes=“minimized”
4
5 <icon src=“opera.png”/>
6
7 <feature name=“opera:speeddial”
8 required=“false”>
9
10 <param name=“url”
11 value=“http://opera.com”/>
12 </feature>
13 </widget>

Referring again to FIG. 4, if the browser 200′ decides at step S445 that a custom icon 310 has been declared by the application code for use in connection with Speed Dialing feature, the browser 200′ will associate such icon 310 with the corresponding location 306 in step S450. Conversely, if the browser 200′ decides at this step that no such custom icon 310 has been declared by the application, the browser 200′ will associate a default placeholder icon 330 with the corresponding location 306 according to step S455. An example of a W3C-Widgets configuration file that requests neither a dynamic graphical representation 320 nor a custom icon 310 is provided below in Table 4:

TABLE 4

1 <widget
2 xmlns = “http://www.w3.org/ns/widgets”>
3
4 <feature name=“opera:speeddial”
5 required=“false”>
6
7 <param name=“url”
8 value=“http://opera.com”/>
9 </feature>
10 </widget>

Regardless of whether a custom icon 310 (step S450) or a placeholder icon 330 (step S455) is to be used in the Speed Dialing feature, the browser 200′ may still expose the aforementioned API to the application according to step S460, thereby allowing the application to control and modify certain aspects of the graphical representation associated with the location 306′ as well as the associated URI. Thus, using this API, the application could replace the icon used for the graphical representation, change the URI which is retrieved when a corresponding user-invocable command is performed, and even add/change a title to be displayed with the icon.

Also, as mentioned earlier, the browser 200′ also exposes the API to the application in step when it determines that a dynamic graphical representation of content 320 is to be used in the Speed Dialing feature (step S440). Specifically, the application may update the content of the dynamic graphical representation 320 through the API. Table 5 below illustrates a specific example of HTML code, which could be found within a background process of a web application or widget, and which uses an API to update a dynamic graphical representation of content 320. In the following example, the API would be exposed on the “opera.contexts.speeddial” attribute of the background process:

TABLE 5

1 <!doctype html
2 <script>
3 //creates a button
4 var button = opera.contexts.toolbar.createItem ({
5 title:‘Weather Extension’
6 icon:‘yr.png’
7 badge: {textContent: “ ”}
8 })
9
10 //adds it to the browser UI
11 opera.contexts.toolbar.addItem( button );
12 document.onload = function getWeather( ){
13 var xhr = new XMLHttpRequest( );
14 //... load weather info ...
15 }
16
17 //Displays weather information in Speed Dial and update UI Item
18 function updateWeather(weatherInfo){
19 var location = weatherInfo.location;
20 if(opera.contexts.speeddial){
21 var sd = opera.contexts.speeddial;
22
23 //change the title
24 sd.title = weatherInfo.location + “ ” +
weatherInfo.forecast;
25
26 //change the URL
27 sd.url = “http://weather.com/” + location;
38 }
29
30 //update the UI item
31 button.icon = weatherInfo.weatherIcon;
32 button.badge.textContent = weatherInfo.temperature;
33 }

Furthermore, as suggested by the particular example of Table 5 (lines 5 and 23-24), the API may allow the application to add and also change a title to be displayed with the graphical representation of the application. According to an exemplary embodiment, the application may be required to initialize a “title” attribute of the API to reflect the application's name. For instance, if the application conforms to W3C-Widgets, the title may need to be initialized to a value equivalent to the “name” attribute of the “widget” element in the configuration document (i.e., equivalent to the value of “widget.name”). However, after initialization, the application may be allowed to change the title attribute to whatever is desired using the API.

Furthermore, while FIG. 3 illustrates titles being displayed only in connection with the thumbnail images 308 and the dynamic representation of content 320, it is also possible to display in connection with custom icons 310 and placeholder icons 330.

Also, it is possible for an application developer to indicate whether or not he or she wishes to break backwards compatibility, i.e., compatibility with browsers 200′ which do not support the Speed Dialing feature. The developer may achieve this by setting a particular attribute in the partition of code corresponding to the initial request for the Speed Dialing feature. For example, if a widget requests availability of the Speed Dialing feature using any one of the configuration files illustrated in Tables 1-4 above, the “required” attribute in the “feature” element may determine whether the widget will be installed within a browser 200′ which does not support the Speed Dialing feature. For instance, if the value of the “required” attribute is set to “false” (as illustrated in each of Tables 1-4), this can be interpreted to mean that the browser 200′ need not support the Speed Dialing feature to install the widget. Conversely, if the value of the “required” attribute is set to “true,” this could mean that the widget is not to be installed in the browser 200′. In addition, if the “required” attribute is entirely missing from the configuration file, its value may automatically default to “true” or “false” depending on the browser's programming.

It should be noted that the figures and tables described above are provided for purpose of example, and not intended to be limiting on the present invention. For instance, the present invention encompasses any obvious modifications to these figures as would be contemplated by persons of ordinary skill in the art. This could include any obvious reordering of the steps illustrated in FIGS. 4 and 5, and/or providing additional obvious steps to the respective processes. Furthermore, while the specific examples in Tables 1-5 above refer to code written in XML, the present invention is not to be limited to any particular coding language or format. The corresponding code could alternatively be written, e.g., in JavaScript Object Notation (JSON), binary code, or in other formats.

While particular embodiments are described above for purposes of example, the present invention covers any and all obvious variations as would be readily contemplated by those skilled in the art.

1. A method comprising:
executing, by a computer processor which is currently running a web browser, the following process:
selecting one or more applications,
associating each selected application with one of a plurality of predefined locations in a browser window,
maintaining in a computer memory, for each selected application, a corresponding graphical representation which on the basis of the selected application is chosen from the following:
a dynamic graphical representation of content of the application;
a custom icon provided in the application; and
a default placeholder icon,
displaying said browser window including the plurality of predefined locations,
for each selected application, displaying the corresponding graphical representation in the associated predefined location, and
associating each of the predefined locations with a user-invocable command to retrieve a data resource associated with the corresponding selected application.

2. The method of claim 1, wherein the process further comprises:
detecting, within the code of a given application, a request to associate the given application with one of the plurality of predefined locations;
determining whether to accept the request; and
if the request is accepted, selecting the given application to be associated with one of the plurality of predefined locations.

3. The method of claim 2, wherein
if the request is accepted and the code declares a view mode for displaying a background process in association with the request, the corresponding graphical representation of the given application is chosen to be a dynamic graphical representation of content which causes a background process of the given application to be displayed.

4. The method of claim 2, wherein
if the request is accepted, and the code declares a custom icon without declaring a view mode for displaying a dynamic graphical representation of content in association with the request, the declared custom icon is chosen as the corresponding graphical representation of the given application.

5. The method of claim 2, wherein
if the request is accepted, and the code declares neither a view mode for displaying a dynamic graphical representation of content nor a custom icon in association with the request, the default placeholder icon is chosen as the corresponding graphical representation of the given application.

6. The method of claim 2, wherein
the code declares a Uniform Resource Locator (URL) in association with the request, and
if the request is accepted, the predefined location associated with the given application is also associated with a user-invocable command to retrieve a data resource corresponding to the declared URL.

7. The method of claim 6, wherein
the web browser includes an application program interface (API), and
if the request is accepted, the API is exposed to the given application in order to allow the given application to perform at least one of:
update the content of the corresponding graphical representation for the given application; and
change the URL which is retrieved in accordance with the associated user-invocable command.

8. The method of claim 2, wherein the process determines whether to accept the request by:
outputting information prompting a user to select whether to accept or deny the request; and
receiving input from the user indicating the user's selection.

9. The method of claim 1, wherein the user-invocable command is invoked by a mouse click on one of the plurality of predefined locations.

10. The method of claim 1, wherein the user-invocable command is invoked by a keystroke combination uniquely associated with one of the plurality of predefined locations.

11. The method of claim 1, wherein the process further comprises:
receiving user input specifying which of the plurality of predefined locations is to be associated with at least one of the selected applications.

12. A non-transitory computer-readable medium on which is stored coded instructions that, when executed by a computer processor during the course of running a web browser, performs the process of claim 1.

13. An apparatus comprising a computer processor which, during the course of running a web browser, performs the process of claim 1.

14. A method comprising:
executing, by a computer processor which is currently running a web browser, the following process:
maintaining a list including one or more applications and one or more web pages,
associating each application and each web page in the list with one of a plurality of predefined locations in a browser window,
maintaining in a computer memory, for each application in the list, a corresponding graphical representation which on the basis of the application is selected from the following:
a dynamic graphical representation of content of the application;
a custom icon provided in the application; and
a default placeholder icon,
displaying said browser window including the plurality of predefined locations,
for each application in the list, displaying the corresponding graphical representation in the associated predefined location, and
associating each of the predefined locations with a user-invocable command to retrieve a data resource associated with the corresponding application or web page.

15. A non-transitory computer-readable medium on which is stored coded instructions that, when executed by a computer processor during the course of running a web browser, performs the process of claim 14.

16. An apparatus comprising a computer processor which, during the course of running a web browser, performs the process of claim 14.
